(19) United States
(12) Patent Application Publication
(10) Pub. No.: US 2006/0230003 A1
(43) Pub. Date: Oct. 12, 2006

(54) Weight detection system for ordered goods and method using the same

(75) Inventors: Min-Tzu Sung, Taipei (TW); Shan-Fa Shih, Taipei (TW); Wen-Yi Chang, Taipei (TW); Po-Wen Lu, Taipei (TW)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/094,293

(22) Filed: Mar. 31, 2005

(51) Int. Cl. G01G 19/413; G06F 17/00; G07B 17/02

(52) U.S. Cl. 705/414; 705/407

(57) ABSTRACT

A weight system and method for ordered merchandizes to detect actual weight of ordered goods and avoid inaccuracy in weighing caused by human errors. The weight detection system for ordered merchandizes includes: a database of orders for storing customers' ordering information; a database of pallet for storing weight of the pallets and quantity of merchandising goods that each pallet can carry; a database of goods list for declaration for storing information required when declaring goods at the Customs; a weight estimation module for calculating the estimated weight of goods in each ordering list; a weighing module for measuring the actual weight of goods in each ordering list; a computation module for computing the difference between the estimated weight and the measured actual weight of goods in each ordering list; and a data accessing module for storing the actual weight of the ordered goods into the database of goods list for declaration provided that the difference between the two is within an acceptable range. The data stored in the database of goods list for declaration is to be used for customs declaration purposes, and the merchandiser need not worry about being fined due to an incorrect weight declaration.

### FIELD OF THE INVENTION

The present invention relates to a weight detection system for ordered goods and a method using the same, and more particularly, to a system and a method for checking whether the weight of ordered goods is accurate or not before declaring.

### DESCRIPTION OF THE PRIOR ART

The actual weight of importing and exporting goods is one of customs duty collecting criteria; hence, providing accurate weight of imports and exports is important for declaring the customs duty. For exportation, before exporting the goods, the merchandizes' related information and the actual weight have to be ready to be provided at the Customs within requested time period, in order to process customs formalities. However there are times where merchandisers could not complete the weighing processes as required by the Customs due to the limited time allocated for preparing goods to be dispatched for exportation. As a result, the merchandisers would be unable to attain the exact weight of the goods to be exported within the time limit allowed by the Customs. This will cause a delay in the scheduled date for the declaration of goods to the Customs which inevitably will cause a delay to the time of shipment. Human error is another possible factor causing an inaccurate weight of goods being reported to the Customs. If the actual weight of the goods does not match the weight reported to the Customs, the merchandisers may be fined.

In order to avoid the situation where the merchandisers would be unable to comply to the requirements of the customs due to the lack of time to complete the weighing process, which as a result would cause a delay to the exportation of goods, a existing system for estimating weight of goods has been put into practice. This system calculates the estimated weight of every individual merchandised item in an order list. However, there has hitherto not been a solution to avoid the human error attribution in the weighing process.

### SUMMARY OF THE INVENTION

In order to solve the problems of the prior art, a primary objective of the present invention is to provide a weight detection system and method for ordered goods. The merchandisers will be able to detect whether the difference between the actual weight and the estimated weight of ordered goods exceeds an acceptable range. If the difference exceeds the acceptable range, the goods will be requested for re-weighing. This is to provide a precise weight for the goods, so that the merchandisers can avoid being fined at the Customs due to incorrect weight declaration.

In order to achieve the above objective, a weight detection system for ordered goods is provided by the present invention. The weight detection system for ordered goods of the present invention comprises a database of orders for storing order-related information such as reference number of order lists, name of clients, name of goods, weight of goods, quantity of ordered goods, price of goods, dimensions of goods, estimated weight and actual weight of goods etc.; a database of pallets for storing weight of pallets, name of the goods and carrying capacity of each pallet; a database of goods list for declaration containing information required when declaring goods at the Customs such as name of the goods, shipment quantity, price of goods, dimensions of goods and actual weight of goods etc.; a weight estimation module for calculating the estimated weight of goods in each order list by obtaining information from the database of orders and the database of pallets; a weighing module for measuring the actual weight of goods in each order list; a computation module for calculating the difference between the actual weight and the estimated weight of goods in each order list, and determining whether the difference exceeds an acceptable range; and a data accessing module for storing the actual weight of goods into the database of goods list for declaration provided that the difference is within the acceptable range. The data stored in the database of goods list for declaration is to be used for customs declaration purposes, and the merchandisers need not worry about being fined due to incorrect weight issues.

The weight detection method for ordered goods of the present invention comprises the following steps of: storing order-related information such as reference number of order lists, name of clients, name, weight, quantity, price and dimensions of the ordered goods into the database of orders; storing weight of pallets, name of goods and carrying capacity of each pallet into the database of pallets; calculating the estimated weight of goods in each order list by obtaining information from the database of orders and the database of pallets (i.e. in particular, the weight and the quantity of goods in each order list from the database of orders, and the weight of pallets and the carrying capacity of each pallet from the database of pallets), and then, storing the estimated weight of the goods into the database of orders; measuring the actual weight of goods in each order list by the weighing module and storing the actual weight of goods into the database of orders; calculating the difference between the actual and the estimated weight of goods in each order list by the computation module; determining whether the difference between the actual and the estimated weight exceeds an acceptable range. If the difference does not exceed the acceptable range, storing the actual weight of goods from the order list into the database of goods list for declaration and generating declaration forms for declaration process. If the difference exceeds the acceptable range, the goods will be requested for re-weighing. The re-weighing process will be repeated until the difference is within the acceptable range for declaration.

In accordance with what mentioned above, the weight detection system and method for goods of the present invention stores order- and pallet-related information into the database of orders and pallets respectively. According to the information of orders and pallets, the estimated weight of goods in each order list will be calculated by the weight estimation module. At the same time, the actual weight of goods in each order list will be measured by the weighing module. The difference between the actual and the estimated weight of goods in each order list will then be calculated. After that, it is determined whether the difference exceeds the acceptable range or not. The actual weight of the goods in each order list will be passed to the database of goods list for declaration provided that the difference does not exceed the acceptable range. The declaration form will then be generated for declaration process at the Customs.

### BRIEF DESCRIPTION OF THE DRAWINGS

A better understanding of the present invention can be obtained when the forgoing detailed description is considered in conjunction with the following drawings, in which:

FIG. 1 is a block diagram of a weight detection system for ordered goods of the present invention.

FIG. 2 is a flow chart showing procedures required in a weight detection method for ordered goods of the present invention.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

### EXAMPLE

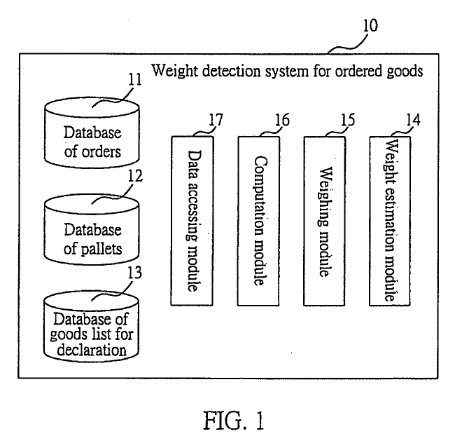

FIG. 1 illustrates a block diagram showing the basic structure of the weight detection system for ordered merchandize of the present invention. As shown in the diagram, the weight detection system for ordered goods of the present invention includes: a database of orders 11, a database of pallets 12, a database of merchandise list for declaration 13, a weight estimation module 14, a weighing module 15, a computation module 16 and a data accessing module 17.

The database of orders 11 contains order-related information such as reference number of order lists, name of clients, name of goods, weight of goods, quantity of ordered goods, price of goods, dimensions of goods, estimated weight and actual weight of goods, etc. The contained information in the database of orders 11 enables the merchandisers to calculate the difference between the estimated and the actual weight of goods in each order list.

The database of pallets 12 contains weight of pallets, name of the goods and carrying capacity of each pallet. The data contained in the database of pallets 12 enables the merchandisers to calculate the estimated weight of goods in each order list.

The database of goods list for declaration 13 contains information required when declaring goods and generating declaration form at the Customs such as name, price, dimensions and actual weight of the goods, shipment quantity etc. In order to simplify the description of the present invention, the database 13 lists the declaration information related to the present invention only. The detailed information of the database 13 depends on the regulations enforced by the Customs in each country.

The weight estimation module 14 reads the name, weight and quantity of ordered goods of each individual order list from the database of orders 11. Based on the name of the goods, the weight estimation module 14 then reads the weight and carrying capacity of pallets from the database of pallets 12. After that, the estimated weight of goods in each order list will be calculated by the following formula: (weight of goods) * (quantity of ordered goods)+(weight of a pallet) * [quantity of ordered goods/carrying capacity of a pallet]=estimated weight of ordered goods, wherein if the outcome of [amount of ordered goods/carrying capacity of a pallet] is not an integer, the decimal is ignored and one is added to the units digit of the outcome.

The weighing module 15 measures the actual weight of goods in each order list for declaration at the Customs within the prescribed time.

The computation module 16 calculates the difference between the actual and the estimated weight of goods in each order list, and determines whether the difference is within an acceptable range, for example, within 3%.

The data accessing module 17 stores the actual weight of goods in each order list into the database of goods list for declaration 13, provided that the difference determined by the computation module 16 does not exceed the acceptable range (i.e. the difference is within the acceptable range and the range is within 3%). The data accessing module 17 also stores information in the database of orders 11 required for declaration, such as name, shipment quantity, price and dimensions of goods etc., into the database of goods list for declaration 13. The information is then used for generating declaration form for goods declaration process.

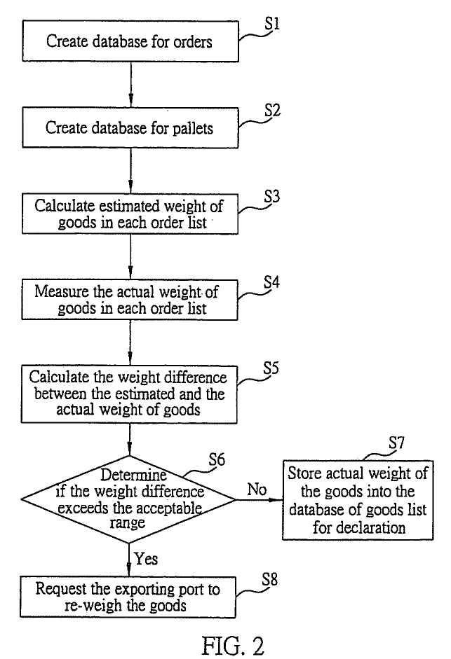

FIG. 2 illustrates a flow chart showing procedures required in the weight detection method for ordered goods of the present invention. As shown in the flow chart, in step S1, the database of orders 11 is created to store order-related information, such as reference number of goods, name of clients, weight of goods, quantity of ordered goods, price of goods, dimensions of goods, etc. These stored data will be used in calculating the estimated weight of goods of each order, and is also used to calculate the difference between the estimated and the actual weight of ordered goods, then move to step S2.

In the step S2, the database of pallets 12 is created to store the weight, name and carrying capacity of pallets. The stored information will also be used to calculate the estimated weight of goods in each order list, and then move to step S3.

In the step S3, the weight estimation module 14 is executed to read the name, weight and ordered quantity of goods from the database of orders 11 and the weight and carrying capacity of pallets from the database of pallets 12. After that, the estimated weight of goods in each order list will be calculated by the following formula: (weight of goods) * (amount of ordered goods)+(weight of a pallet) * [quantity of ordered goods/carrying capacity of a pallet]=estimated weight of ordered goods. The data accessing module 17 will be executed to store the estimated weight of goods into the database of orders 11, wherein, if the outcome of [amount of ordered goods/carrying capacity of a pallet] is not an integer, the decimal is ignored and one is added to the units digit of the outcome, then move to step S4.

In the step S4, the weighing module 15 is executed to measure the actual weight of goods in each order list, and the data accessing module 17 is also executed to store the actual weight of the goods in each order list into the database of orders 11, and then move to the step S5.

In the step S5, the computation module 16 is executed to calculate the difference between the estimated and the actual weight of goods in each order list, and then move to the step S6.

In the step S6, the estimated and the actual weight of the goods in each order list is compared to see if the difference between the two exceeds an acceptable range (the difference in this embodiment is set to be within 3%). If the difference does not exceed the acceptable range (i.e. the difference is within the acceptable range), then move to step S7. If the difference exceeds the acceptable range, then move to step S8.

In the step S7, the data accessing module 17 is executed to pass the actual weight of ordered goods into the database of orders 11, provided that the difference does not exceed the acceptable range. And the data accessing module 17 also pass declaration-related information contained in the database of orders 11 (such as the name of goods, ordered quantity, price of goods, volume of goods, etc) into the database of merchandise list for declaration 13 in order to generate declaration form for declaration process.

In the step S8, the declaration process is suspended when the difference of the order exceeds the acceptable range, and the exporting port is requested to re-weigh the ordered goods until the actual weight is smaller than the acceptable range, thereafter the declaration process can be continued.

In accordance with what mentioned above, the weight detect system and method for ordered goods of the present invention is achieved by storing order-related information into the database of orders, and storing pallets-related information into the database of pallets, then calculating the estimated weight of goods in each order list according to the information provided from the database of orders and pallets, at the same time making the weighing module measure the actual weight of goods in each order list, then making the computation module calculate the difference between the actual and the estimated weight of goods in each order list, and determining whether the difference exceeds the acceptable range, at last passing the actual weight of goods in each order list, provided that the difference with the estimated weight of goods does not exceed the acceptable range, into the database of goods list for declaration.

The embodiments described above are only to illustrate aspects of the present invention; it should not be construed as to limit the scope of the present invention in any way.

While the invention has been described in detail with reference to specific embodiments thereof, it will be apparent in the art that various changes and modifications can be made, and equivalents employed, without departing from the scope of the claims.

What is claimed is:

1. A weight detection system for ordered goods comprising:
a database of orders for storing order-related information including at least description, quantity and weight of ordered goods;
a database of pallets for storing information related to pallets used for carrying the goods, the information including at least weight and carrying capacity of the pallets;
a database of goods list for declaration for storing at least information related to customs declaration of the goods;
a weight estimation module for reading the description, the quantity and the weight of the ordered goods from the database of orders and also the weight and the carrying capacity of the pallets from the database of pallets, and calculating an estimated weight of the ordered goods using a predetermined formula for weight calculation based on the read information;
a weighing module for measuring an actual weight of the goods;
a computation module for calculating the difference between the actual and the estimated weight of the goods; and
a data accessing module for storing the actual weights of the ordered goods into the database of goods list for declaration provided that the difference is within a predetermined acceptable range.

2. The system as claimed in claim 1, wherein the formula for weight calculation is: (weight of goods) * (quantity of goods)+(weight of a pallet) * [quantity of goods/carrying capacity of a pallet]=estimated weight of goods.

3. The system as claimed in claim 2, wherein when the outcome of [amount of ordered goods/carrying capacity of each pallet] is not an integer, the decimal is ignored and one is added to the units digit of the outcome.

4. The system as claimed in claim 1, wherein the weighing module is a platform weighting scale.

5. The system as claimed in claim 1, wherein the weighing module is a weigher.

6. The system as claimed in claim 1, wherein the acceptable range of the difference is predetermined by a user.

7. A weight detection method for ordered goods provided comprising the following steps of:
storing order-related information including at least description, quantity and weight of ordered goods into a database of orders and pallet-related information including at least weight and carrying capacity of the pallets into a database of pallets;
reading the description, the quantity and the weight of the goods from the database of orders and also the weight and the carrying capacity of the pallets from the database of pallets, and calculating an estimated weight of the ordered goods using a predetermined formula for weight calculation based on the read information;
measuring the actual weight of the goods;
calculating the difference between the actual and the estimated weight of the goods;
storing the actual weights of the ordered goods into the database of goods list for declaration provided that the difference is within a predetermined acceptable range; and
suspending declaration and re-weighing goods when the difference is out of the predetermined acceptable range.

8. The method as claimed in claim 7, further comprising storing the estimated weight of goods into the database of orders.

9. The method as claimed in claim 7, further comprising storing the actual weight of goods into the database orders.

10. The method as claimed in claim 7, further comprising passing declaration-related information stored in the database of orders into a database of goods list for declaration in order to generate declaration forms for declaration process.

11. The method as claimed in claim 7, wherein the predetermined formula for weight calculation is: (weight of goods) * (amount of goods)+(weight of a pallet) * [amount of goods/carrying capacity of a pallet]=estimated weight of ordered goods.

12. The method as claimed in claim 11, wherein when the outcome of [amount of ordered goods/carrying capacity of each pallet] is not an integer, the decimal is ignored and one is added to the units digit of the outcome.

13. The method as claimed in claim 7, wherein the predetermined acceptable difference range is determined by a user.
